(19) United States
(12) Patent Application Publication
(10) Pub. No.: US 2013/0120526 A1
(43) Pub. Date: May 16, 2013

(54) ASSOCIATION OF MVC STEREOSCOPIC VIEWS TO LEFT OR RIGHT EYE DISPLAY FOR 3DTV

(71) Applicant: Mandayam A. Narasimhan, San Diego, CA (US)

(72) Inventor: Mandayam A. Narasimhan, San Diego, CA (US)

(73) Assignee: GENERAL INSTRUMENT CORPORATION, Horsham, PA (US)

(21) Appl. No.: 13/563,277

(22) Filed: Jul. 31, 2012

Related U.S. Application Data
(60) Provisional application No. 61/559,149, filed on Nov. 14, 2011.

(51) Int. Cl. H04N 13/00

(52) U.S. Cl. 348/43; 348/E13.001

(57) ABSTRACT

A method of delivering video data representing left and right eye views of a scene encoded in accordance with multiview video coding (MVC) from a transmitter to a receiver over an MPEG-2 systems standard stream, includes receiving at a transmitter an input video elementary stream conveying data encoded as a base view and an enhancement view, wherein the base view represents a specific one of the left and right eye views and the enhancement view represents the other of the left and right eye views. An MPEG-2 systems standard multiplexer at the transmitter generates an MPEG-2 systems standard stream that is derived from the input video elementary stream and conveys association information associating the base view with the specific one of the left and right eye views. The MPEG-2 systems standard stream is transmitted from the transmitter to the receiver.

### CROSS-REFERENCE TO RELATED APPLICATION

This application claims benefit under 35 USC 120 of U.S. Provisional Application No. 61/559,149 filed Nov. 14, 2011, the entire disclosure of which is hereby incorporated by reference herein for all purposes.

### BACKGROUND OF THE INVENTION

The subject matter of this application relates to association of MVC stereoscopic views to left or right eye display for 3DTV.

Referring to FIG. 1 of the drawings, in a conventional method of distributing 2D video content a video encoder 10 receives raw video data, typically in the HD-SDI format defined in SMPTE 292M, from a source (not shown) such as a camera. The video encoder utilizes the HD-SDI data to generate a video elementary stream and supplies the video elementary stream to a video packetizer 14, which produces a video packetized elementary stream (PES) composed of variable length packets of up to 64 kbytes. Similarly, an audio encoder (not shown) receives raw audio data from, for example, a microphone and supplies an audio elementary stream to an audio packetizer, which creates an audio PES composed of variable length packets.

In generating the video elementary stream, the video encoder compresses the raw video data utilizing well-known prediction techniques based on correlations between successive pictures represented by the raw video data. The video elementary stream represents a sequence of I (intra-coded) pictures, P (predictively coded) pictures and B (bidirectional predictively coded) pictures organized as a succession of groups of pictures (GOPs) starting with an I picture. Typically, each packet of the video PES contains one or more encoded pictures.

The video and audio packetizers may supply the video and audio PESs to a transport stream multiplexer 18, which assigns respective program identifiers (PIDs) to the video PES and the audio PES and organizes the variable-length packets of the video and audio PESs as fixed-length MPEG-2 transport stream (TS) packets each having a header that includes the PID of the PES and a payload containing PES video (or audio) data.

The video and audio elementary streams conveyed by the video and audio PESs are considered to be services included in the single program transport stream (SPTS) that is output by the transport stream multiplexer. The SPTS may include other services also, such as second language audio and program guide data, conveyed by respective packetized elementary streams having respective PIDs assigned thereto.

The TS packets of the SPTS also include a program map table (PMT), which contains the PIDs of the elementary streams conveyed by the SPTS and may contain other signaling mechanisms.

The SPTS that is output by the transport stream multiplexer 18 may be supplied to a program multiplexer 22 that combines that SPTS with other transport streams, conveying other programs, to produce a multi-program transport stream (MPTS). The MPTS is transmitted over a channel to a receiver 24 at which a program demultiplexer 26 separates a selected SPTS from the MPTS and supplies it to a transport stream demultiplexer 30. The receiver 24 may be implemented in a set-top box (STB) connected to a digital TV appliance 25. It will be appreciated by those skilled in the art that the SPTS that is output by the transport stream multiplexer 18 may be transmitted directly to the transport stream demultiplexer 30 without first being combined with other transport streams to create the MPTS but in either case the transport stream demultiplexer receives the fixed-length transport stream packets of the selected SPTS and separates them on the basis of PID, depacketizes the transport stream packets to recreate the PES packets, and directs the video PES to a so-called video transport system target decoder (T-STD) 34 and the audio PES to an audio T-STD 38. The subject matter of this application is concerned with processing video data and accordingly we will not discuss the audio decoder further.

The video T-STD 34 comprises a video depacketizer 40 and a video decoder 42. The video depacketizer 40 receives the video PES from the transport stream demultiplexer and provides an encoded bitstream to the video decoder, which decodes the bitstream and outputs a stream of pictures in display order to the TV appliance 25. Typically, the decoder 42 is connected to the TV appliance through an HDMI (High Definition Multimedia Interface) cable. An HDMI encoder in the STB creates an HDMI compliant digital signal, which passes to an HDMI decoder in the TV appliance through the HDMI cable. The HDMI decoder generates appropriate signals for driving the display circuits of the TV appliance.

The MPEG-2 transport stream, which is defined in the MPEG-2 systems standard (ISO/IEC 13818-1), is widely used for delivery of encoded video over an error prone channel. The MPEG-2 systems standard also defines the MPEG-2 program stream, which may be used for transmission of encoded video in an error free environment. FIG. 1 illustrates transmission of the video PESs as a program stream to a video program system target decoder (P-STD) 50 as an alternative to delivery as a transport stream to the video T-STD 34. The term “MPEG-2 systems standard stream” is used herein to refer to both the MPEG-2 transport stream and the MPEG-2 program stream. It will be appreciated that regardless of whether the video content is delivered over a program stream or a transport stream, other functional blocks than those described and illustrated above might be required in a practical implementation of the method described.

The bitstream produced by the video encoder 10 may comply with the video compression standard that is specified in ISO/IEC 14496-10 (MPEG-4 part 10) Advanced Video Coding (AVC), commonly referred to as H.264/AVC. Those skilled in the art will understand that H.264/AVC allows for a picture to be segmented into slices and that a picture may be composed of one or more I slices, P slices and B slices. For simplicity and clarity, however, we will confine the following discussion to pictures. The first picture, or access unit, of a coded video sequence (which corresponds to the GOP of previous video compression standards) must be an IDR (instantaneous decoder refresh) access unit, which is defined as an access unit that contains only I slices or SI (switched intra-coded) slices.

Annex H of H.264/AVC prescribes an extension of H.264/AVC known as multiview video coding or MVC, which provides efficient compression of multiple views of the same scene.

Referring to FIG. 2, an MVC video encoder 110 receives raw video data, typically as HD-SDI data streams, from respective sources representing views of the same scene. Three sources and three data streams suffice to illustrate the principles of Annex H but it will be appreciated by those skilled in the art that there could be two sources or four or more sources. The MVC encoder 110 generates a single compressed video elementary stream conveying a succession of coded video sequences each starting with an IDR access unit and containing access units derived from the three views respectively, using the temporal and inter-view correlations among the three streams. The IDR access unit at the start of a coded video sequence may be derived from any one of the three streams. In general, the IDR access unit at the start of a coded video sequence will be derived from a different stream from the IDR access unit at the start of the immediately preceding coded video sequence.

The compressed video elementary stream is packetized by the video packetizer 114 and the video PES passes to a transport stream multiplexer 118. The MPEG-2 systems standard does not allow a single PID to be assigned both to an IDR access unit and to access units derived from other views. Accordingly, the transport stream multiplexer 118 separates the coded video sequence into a primary sequence of access units containing the IDR access unit and other access units derived from the same view (referred to as the base view) and a secondary sequence of access units containing access units derived from additional views (two additional views in the case of the example) and assigns respective PIDs to the two sequences. Similarly to the transport stream multiplexer 18 shown in FIG. 1, the transport stream multiplexer 118 shown in FIG. 2 organizes the variable-length packets of the video PES and the corresponding audio PES as fixed-length TS packets and transmits the TS packets to a transport stream demultiplexer 130, either directly or as part of a multi-program transport stream through a program multiplexer/demultiplexer 122, 126. The transport stream demultiplexer 130 recovers the succession of coded video sequences and passes the video PES packets to a video depacketizer 140, which depacketizes the video PES and reconstructs the video elementary stream. An MVC video decoder 142 decodes the access units and supplies three streams of presentation units, corresponding to the three streams of pictures received by the MVC video encoder 110, to an HDMI encoder 146. The HDMI encoder receives control signals from a display appliance 125, such as a video game console, via an HDMI decoder 148 and in response to the control signals the HDMI encoder creates an HDMI compliant digital signal conveying a selected one of the three views to the HDMI decoder through an HDMI cable. The HDMI decoder generates appropriate signals for driving the display circuits of the display appliance for displaying the selected view.

Multiview video coding has been applied to the case in which the multiple views are left and right eye stereoscopic views, in order to support delivery of 3D video content to a 3D capable TV appliance. Referring to FIG. 3, left and right cameras 208L, 208R provide raw video data representing left and right eye views of a scene and the MVC encoder 110 produces an encoded bitstream conveying access units derived from the left and right eye views that enable the MVC decoder 142, which decodes the access units and recovers the corresponding presentation units, to supply a sequence of presentation units to the HDMI encoder 146. A signaling mechanism outside the TS bitstream enables the HDMI encoder to determine whether a given presentation unit represents a left eye view or a right eye view. The HDMI decoder 148 sends control signals to the HDMI encoder calling for a sequence of left and right eye view presentation units, as required by the display circuits of the TV appliance 225 in order to provide a 3D display, and the HDMI encoder responds to the control signals by supplying the proper sequence of left and right eye view presentation units to the HDMI decoder 148. These extensions of MVC are not applicable to a signal that is to be transmitted over an MPEG-2 system standard stream because the MPEG-2 systems standard does not currently provide a mechanism for preserving the left and right eye view information.

Neither the H.264/AVC video compression standard nor the MPEG-2 systems standard provides a signaling mechanism for providing information that associates presentation units or access units with the hand (left or right) of the view represented by the presentation unit or access unit. Absence of such a standardized mechanism limits development of applications of MVC to delivery of 3D content.

### SUMMARY OF THE INVENTION

According to a first aspect of the subject matter of this application there is provided a method of delivering video data representing left and right eye views of a scene encoded in accordance with multiview video coding (MVC) from a transmitter to a receiver over an MPEG-2 systems standard stream, comprising receiving at the transmitter an input video elementary stream conveying data encoded as a base view and an enhancement view, wherein the base view represents one of the left and right eye views and the enhancement view represents the other of the left and right eye views, employing an MPEG-2 systems standard multiplexer at the transmitter to generate an MPEG-2 systems standard stream that is derived from the input video elementary stream and conveys association information associating the base view with said one of the left and right eye views, transmitting the MPEG-2 systems standard stream from the transmitter, receiving the MPEG-2 systems standard stream at the receiver, and employing an MPEG-2 systems standard demultiplexer at the receiver to generate an output video elementary stream derived from the MPEG-2 systems standard stream, wherein the output video elementary stream conveys data encoded as a base view and an enhancement view, and recover the association information from the MPEG-2 systems standard stream.

According to a second aspect of the subject matter of this application there is provided a method of delivering video data representing left and right eye views of a scene encoded in accordance with multiview video coding (MVC) from a transmitter to a receiver over an MPEG-2 systems standard stream, comprising receiving at a transmitter an input video elementary stream conveying data encoded as a base view and an enhancement view, wherein the base view represents one of the left and right eye views and the enhancement view represents the other of the left and right eye views, employing an MPEG-2 systems standard multiplexer at the transmitter to generate an MPEG-2 systems standard stream that is derived from the input video elementary stream and conveys association information associating the base view with said one of the left and right eye views, and transmitting the MPEG-2 systems standard stream from the transmitter.

According to a third aspect of the subject matter of this application there is provided a method of processing an MPEG-2 systems standard stream that conveys video data encoded in accordance with multiview video coding (MVC) and representing a base view and an enhancement view of a scene, and also conveys association information associating the base view with one of a left eye view and a right eye view of a scene, comprising employing an MPEG-2 systems standard demultiplexer to generate an output video elementary stream derived from the MPEG-2 systems standard stream, wherein the output video elementary stream conveys data encoded as a base view and an enhancement view, and recover the association information from the MPEG-2 systems standard stream.

According to a fourth aspect of the subject matter of this application there is provided a non-transitory computer readable medium containing software that, when executed by a computer having an input for receiving a signal conveying video data representing left and right eye views of a scene encoded in accordance with multiview video coding (MVC) from a transmitter to a receiver over an MPEG-2 systems standard stream, delivers the data to a receiver by a method that includes receiving at a transmitter an input video elementary stream conveying data encoded as a base view and an enhancement view, wherein the base view represents one of the left and right eye views and the enhancement view represents the other of the left and right eye views, employing an MPEG-2 systems standard multiplexer at the transmitter to generate an MPEG-2 systems standard stream that is derived from the input video elementary stream and conveys association information associating the base view with said one of the left and right eye views, and transmitting the MPEG-2 systems standard stream from the transmitter.

According to a fifth aspect of the subject matter of this application there is provided a non-transitory computer readable medium containing software that, when executed by a computer having an input for receiving an MPEG-2 systems standard stream that conveys video data encoded in accordance with multiview video coding (MVC) and representing a base view and an enhancement view of a scene, and also conveys association information associating the base view with one of a left eye view and a right eye view of a scene, processes the MPEG-2 systems standard stream by a method that comprises employing an MPEG-2 systems standard demultiplexer to generate an output video elementary stream derived from the MPEG-2 systems standard stream, wherein the output video elementary stream conveys data encoded as a base view and an enhancement view, and recover the association information from the MPEG-2 systems standard stream.

### BRIEF DESCRIPTION OF THE DRAWINGS

For a better understanding of the invention, and to show how the same may be carried into effect, reference will now be made, by way of example, to the accompanying drawings, in which:

FIG. 1 is a block schematic illustration of the architecture of a first system for supplying compressed video material for presentation,

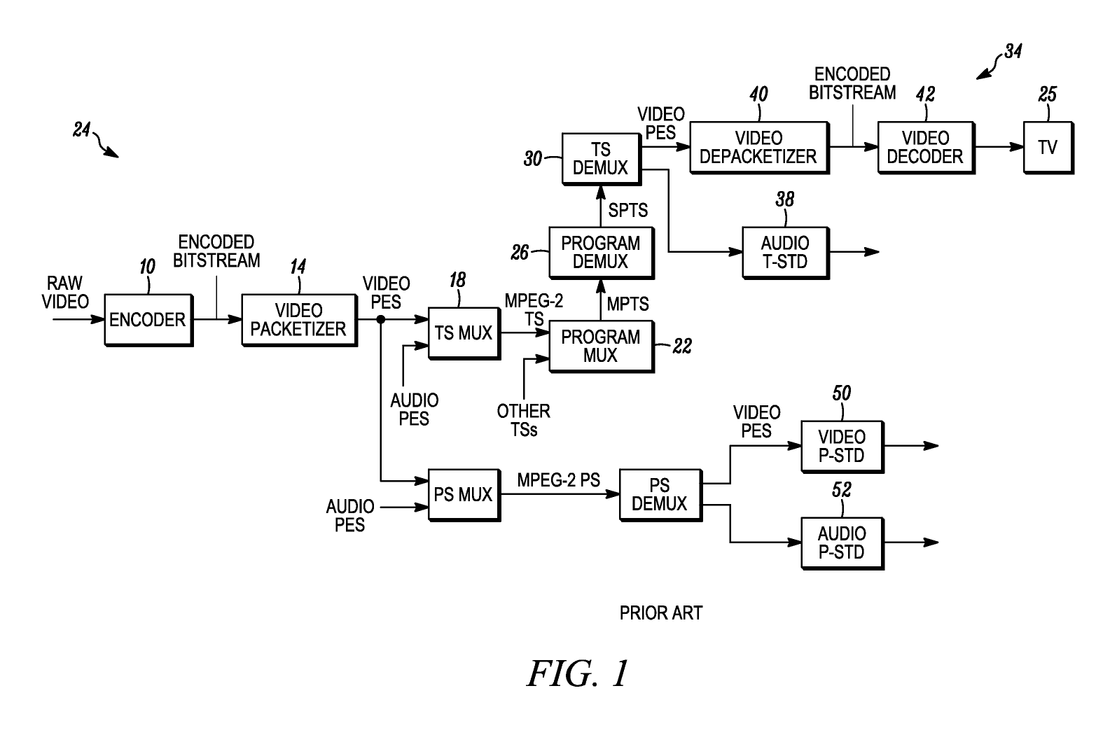

FIG. 2 is a block schematic illustration of the architecture of a second system for supplying compressed video material for presentation,

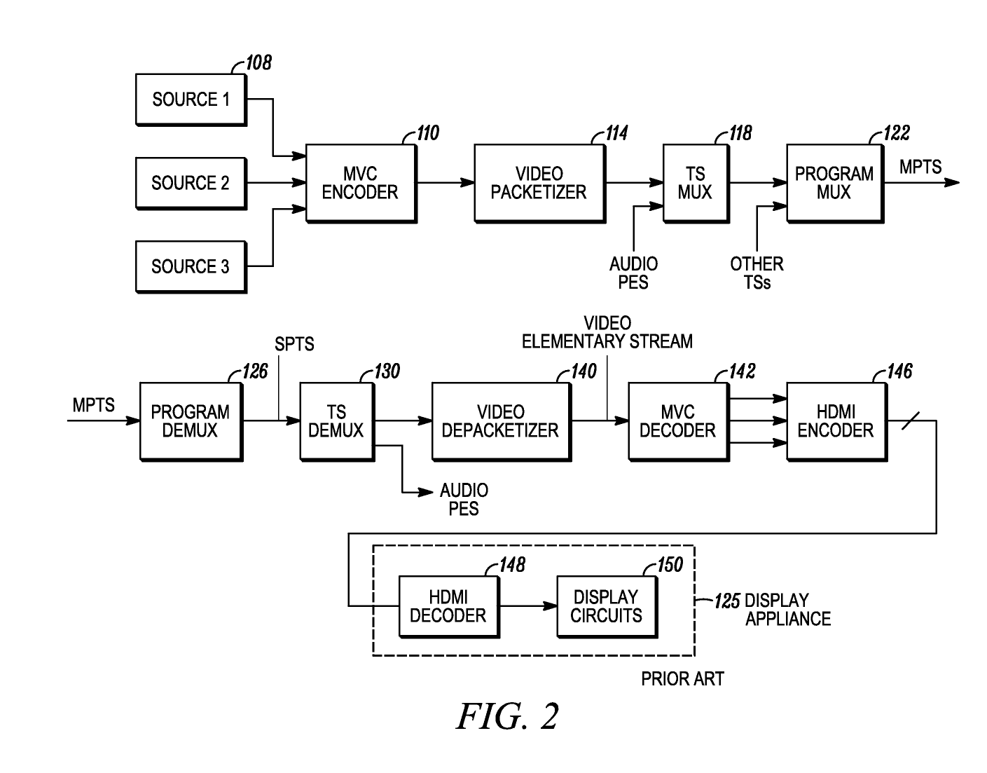

FIG. 3 is a block schematic illustration of the architecture of a third system for supplying compressed video material for presentation,

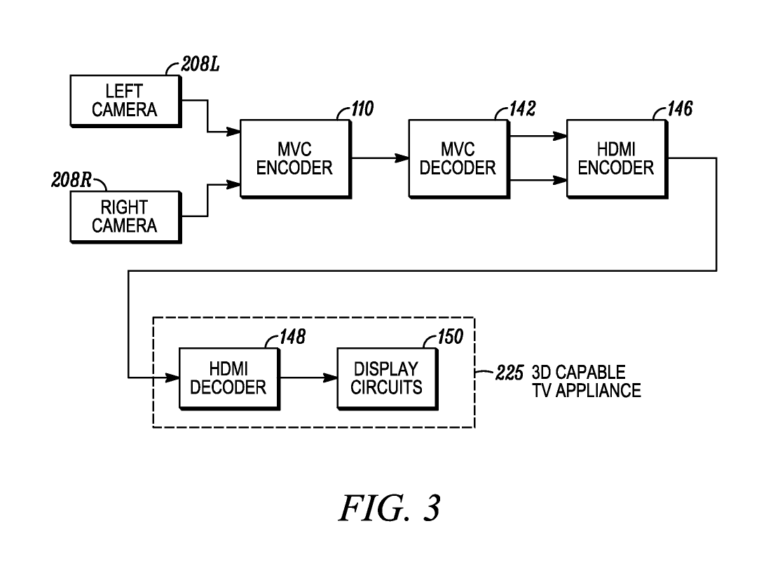

FIG. 4 is a block schematic illustration of the architecture of a fourth system for supplying compressed video material for presentation, and

FIG. 5 is a block schematic diagram of a computing machine that may be used to implement parts of the processes described with reference to FIG. 4.

### DETAILED DESCRIPTION

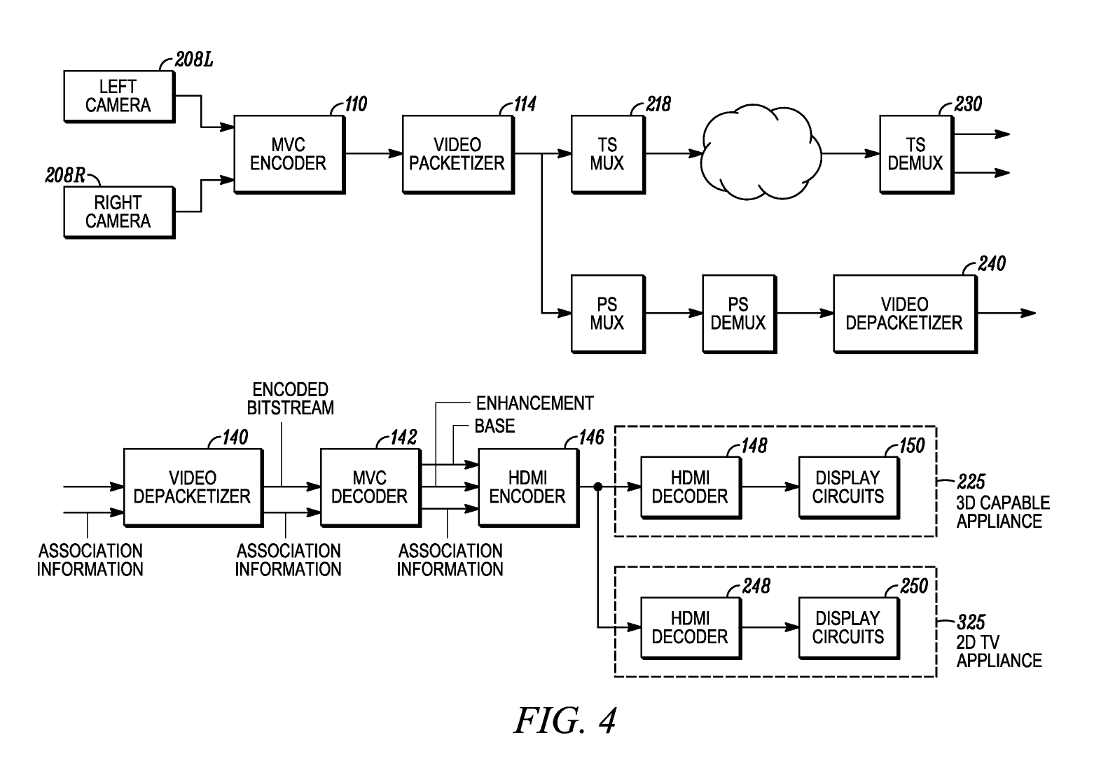

Each coded video sequence produced by the MVC encoder 110 shown in FIG. 4 starts with an IDR picture, which may be derived from the left eye view or the right eye view. The view (left or right eye) that provides the IDR picture is the base view for the coded video sequence; the other view is the enhancement view. In general, the base view for a given coded video sequence is not the same (left eye or right eye) as the base view for the immediately preceding coded video sequence.

The transport stream multiplexer 218 shown in FIG. 4 organizes the variable-length PES packets for a coded video sequence received from the video packetizer in two component sequences of fixed-length TS packets. One component sequence (referred to herein as the primary sequence) contains the PES packets that convey the base view pictures and is assigned a primary PID. The other component sequence (the secondary sequence) contains the PES packets that convey the enhancement view pictures and is assigned a secondary PID. It will be appreciated that the PES packets of the primary sequence convey the IDR picture with which the coded video sequence starts and that the secondary sequence does not convey an IDR picture. The secondary sequence starts with a so-called anchor picture. It will also be appreciated that if the primary sequence derived from the first of two consecutive coded video sequences conveys right eye view pictures, in general the primary sequence derived from the second of the two coded video sequence will convey left eye view pictures.

The transport stream multiplexer 218 receives information that explicitly associates the base view of the current coded video sequence with the appropriate (left or right) eye view. This association information is ultimately derived from the association of the cameras with the left and right eye views respectively and may be included in a supplemental enhancement information (SEI) message produced by the MVC encoder or it may be provided to the TS multiplexer by a signaling mechanism separate from the video data provided by the cameras.

The program map table (PMT) of the MPEG-2 transport stream produced by the transport stream multiplexer 218 may contain program specific information (PSI), i.e. information about the program conveyed by the transport stream. The PSI may include descriptors containing standards-defined or user-defined data elements. For example, the program map table may include a video_stream_descriptor containing coding parameters of a video elementary stream. The descriptors may be used to signal information about the program to the T-STD. Similar descriptors may be conveyed in a program stream map of an MPEG-2 program stream to signal information about the program to the P-STD.

The TS multiplexer 218 includes a descriptor processor that receives the association information and generates a view association descriptor that contains a parameter having a value left or right depending on whether the association information indicates that the base view of the current coded video sequence is the left eye view or the right eye view. The transport stream multiplexer 218 includes the view association descriptor in the PMT of the transport stream that is output by the transport stream multiplexer.

The single program transport stream is delivered over a signal propagation medium to a transport stream demultiplexer 230. The signal propagation medium may include any suitable medium or combination of media, such as cable TV distribution network, the Internet, and wireless transmitters and receivers. The SPTS may be incorporated in an MPTS for delivery over the signal propagation medium.

The transport stream demultiplexer 230 receives the SPTS conveying the primary and secondary component sequences, derived from the coded video sequences provided to the transport stream multiplexer 218, separates the primary and secondary component sequences based on the respective PIDs and recombines the primary and secondary component sequences to recreate PES packets containing the succession of coded video sequences. The video PES packets pass to the video depacketizer, which depacketizes the video PES packets and reconstructs the video elementary stream and supplies it to the MVC decoder 142. For each coded video sequence, the MVC decoder decompresses the access units and generates two sequences of presentation units, corresponding to the base view and the enhancement view respectively, and supplies the two sequences of presentation units to the HDMI encoder 146.

The transport stream demultiplexer 230 also recovers the association information from the view association descriptor and passes the association information to the HDMI encoder. The association information may be passed from the TS demultiplexer to the HDMI encoder via the MVC decoder, as schematically indicated in FIG. 4, for example in an SEI message that the TS demultiplexer includes in the bitstream supplied to the video depacketizer, or it may be passed directly from the TS demultiplexer to the MVC decoder. In the former case, the association information is synchronized with the coded video sequences by virtue of the structure of the video PES; in the latter case it is important to ensure that the association information is synchronized with the coded video sequences.

In order to provide a proper 3D display, the HMDI decoder 148 sends control signals to the HDMI encoder 146 calling for an alternating sequence of left eye view pictures and right eye view pictures. The HDMI encoder uses the synchronized association information to determine whether the base view picture is a left eye view picture or a right eye view picture and uses the two sequences of presentation units and the association information to create an HDMI compliant digital signal conveying the proper sequence of left eye view pictures and right eye view pictures, at the times required by the control signals provided by the HDMI decoder, and supplies the HDMI signal to the HDMI decoder in the TV appliance through an HDMI cable. The 3D capable TV appliance is then able to provide a proper 3D display.

The video PES that is output by the video packetizer 114 may also be conveyed to a video depacketizer 240 by an MPEG-2 program stream. As shown in FIG. 4, the video PES packets are delivered to a program stream multiplexer for forming the program stream, which passes to a program stream demultiplexer. The program stream demultiplexer outputs the video PES packets to the depacketizer 240.

Similarly to the transport stream case, the program stream multiplexer receives the association information either in an SEI message or separately from any SEI messages received from the MVC encoder. The PS multiplexer includes the association information in a descriptor that is conveyed by the program stream map of the program stream. The PS demultiplexer recovers the association information and supplies it to the video depacketizer.

In the event that the HDMI encoder is connected to a 2D TV appliance 325, the HDMI decoder 248 does not call for an alternating sequence of left eye view pictures and right eye view pictures. The HDMI encoder 146 provides a sequence of single eye view pictures. The single eye view pictures will generally alternate between the base view and the enhancement view. The HDMI decoder 248 generates appropriate signals for driving the display circuits 250 of the TV appliance for displaying the single eye view. Thus, the delivery system shown in FIG. 4 is backwardly compatible with a 2D TV appliance.

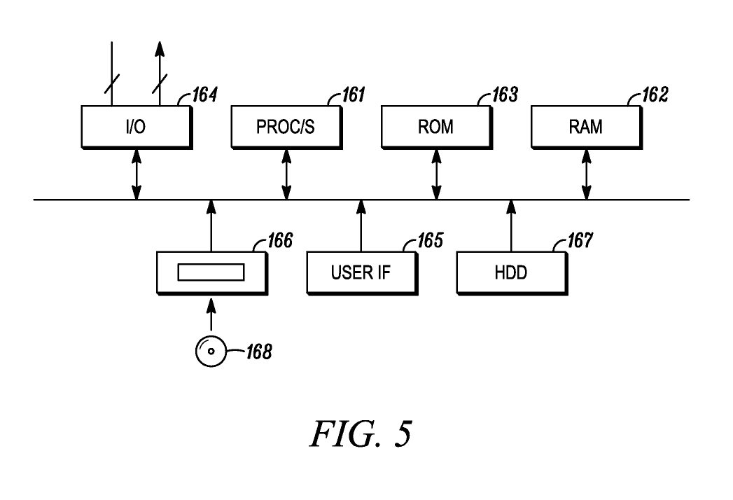

Referring to FIG. 5, one or more of the functional blocks shown in FIG. 4 for producing the transport stream or the program stream, or one or more of the functional blocks shown in FIG. 4 for receiving the transport stream or the program stream and providing the HDMI compliant signal to the appliance 225 or 325, may be implemented using a computer comprising at least one processor 161, random access memory 162, read only memory 163, I/O devices 164 (including suitable adaptors for receiving and transmitting bitstreams), a user interface 165, a CD ROM drive 166 and a hard disk drive 167, configured in a generally conventional architecture. The computer operates in accordance with a program that is stored in a non-transitory computer readable medium, such as the hard disk drive 167 or a CD-ROM 168, and is loaded into the random access memory 162 for execution. The program is composed of instructions such that when the computer receives a signal representing the input of the functional block or blocks, by way of a suitable interface included in the I/O devices 164, the computer allocates memory to appropriate buffers and utilizes other suitable resources and functions to perform the various operations that are described above as being performed by the functional block or blocks.

It will be appreciated by those skilled in the art that the program might not be loadable directly from the CD-ROM 168 into the random access memory utilizing the CD-ROM drive 166 and that generally the program will be stored on the CD-ROM or other distribution medium in a form that requires the program to be installed on the hard disk drive 167 from the CD-ROM 168.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. For example, although the description of FIG. 4 refers to the view association descriptor as containing information that indicates whether the base view is the left eye view or the right eye view, the descriptor could contain information that indicates whether the enhancement view is the left eye view or the right eye view, or information that indicates explicitly both the hand (left or right) of the base view and the hand of the enhancement view. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of delivering video data representing left and right eye views of a scene encoded in accordance with multiview video coding (MVC) from a transmitter to a receiver over an MPEG-2 systems standard stream, comprising:
receiving at a transmitter an input video elementary stream conveying data encoded as a base view and an enhancement view, wherein the base view represents one of the left and right eye views and the enhancement view represents the other of the left and right eye views,
employing an MPEG-2 systems standard multiplexer at the transmitter to generate an MPEG-2 systems standard stream that is derived from the input video elementary stream and conveys association information associating the base view with said one of the left and right eye views, and
transmitting the MPEG-2 systems standard stream from the transmitter.

2. A method according to claim 1, wherein the MPEG-2 systems standard stream is a transport stream and the method comprises conveying the association information by a descriptor of the transport stream.

3. A method according to claim 1, wherein the MPEG-2 systems standard stream is a program stream and the method comprises conveying the association information by a descriptor of the program stream.

4. A method of processing an MPEG-2 systems standard stream that conveys video data encoded in accordance with multiview video coding (MVC) and representing a base view and an enhancement view of a scene, and also conveys association information associating the base view with one of a left eye view and a right eye view of a scene, comprising:
employing an MPEG-2 systems standard demultiplexer to generate an output video elementary stream derived from the MPEG-2 systems standard stream, wherein the output video elementary stream conveys data encoded as a base view and an enhancement view, and recover the association information from the MPEG-2 systems standard stream.

5. A method according to claim 4, comprising delivering the output video elementary stream to a 3D capable display device via an interface that receives the association information and provides a succession of left eye view pictures and right eye view pictures to the display device in accordance with the association information.

6. A method according to claim 4, wherein the MPEG-2 systems standard stream is a transport stream that conveys the association information by a descriptor of the transport stream.

7. A method according to claim 4, wherein the MPEG-2 systems standard stream is a program stream that conveys the association information by a descriptor of the program stream.

8. A non-transitory computer readable medium containing software that, when executed by a computer having an input for receiving an MPEG-2 systems standard stream that conveys video data encoded in accordance with multiview video coding (MVC) and representing a base view and an enhancement view of a scene, and also conveys association information associating the base view with one of a left eye view and a right eye view of a scene, processes the MPEG-2 systems standard stream by a method that comprises:
employing an MPEG-2 systems standard demultiplexer to generate an output video elementary stream derived from the MPEG-2 systems standard stream, wherein the output video elementary stream conveys data encoded as a base view and an enhancement view, and recover the association information from the MPEG-2 systems standard stream.
